(19) United States
(12) Patent Application Publication
(10) Pub. No.: US 2007/0259142 A1
(43) Pub. Date: Nov. 8, 2007

(54) Rigid and semirigid packaging articles

(75) Inventors: Andrew John Lischefski, Tampere (FI); Christopher Wayne Nimis, Oshkosh, WI (US)

Correspondence Address: BEMIS COMPANY, INC., 2200 BADGER AVENUE, OSHKOSH, WI, 54904, US

(73) Assignee: Curwood, Inc., Oshkosh, WI (US)

(21) Appl. No.: 11/416,966

(22) Filed: May 3, 2006

(51) Int. Cl. B32B 27/08

(52) U.S. Cl. 428/35.7

(57) ABSTRACT

The present invention relates to packaging articles comprising a rigid or semirigid tray which has a receptacle cavity comprising a thermoplastic multilayer film. The receptacle cavity is integrally formed from a thermoplastic multilayer film and is defined by a bottom panel, an upstanding sidewall and a mouth. The thermoplastic multilayer film includes at least any rigid or semirigid component and an oxygen barrier component comprising a first polyamide layer, an ethylene/vinyl alcohol copolymer layer, a second polyamide layer, such that the ethylene/vinyl alcohol copolymer layer is in direct contact with both the first and second polyamide layers.

### BACKGROUND OF THE INVENTION

The present invention generally relates to rigid and semirigid packaging articles, and more specifically, to packaging articles having a rigid and semirigid tray suitable for containing oxygen-sensitive food and non-food products.

Rigid and semirigid thermoplastic containers are well known and are often used to package perishable food items, such as meat and dairy products, and the like, and non-food items, such as medical supplies and devices. In general, these containers provide at least one shaped cavity or tray defined by a bottom panel and a side wall within which a product is supported and may be protected against environmental contamination when the container is sealed. Rigid and semirigid containers may be produced by such thermoforming techniques as generally recognized in the art which may include vacuum forming, pressure forming, plug assist or mechanical forming processes. Examples of rigid and semirigid thermoplastic food containers and methods used for producing these containers are described in U.S. Pat. Nos. 3,498,018; 4,277,931; 4,411,122; 4,577,757; 4,688,369; 4,709,535; 5,031,383; 5,058,761; 5,558,891; 5,702,743; 6,408,598; 6,912,828 and 7,017,774 which are incorporated herein by reference in their entireties. In many instances, these containers include an oxygen barrier material to protect an oxygen-sensitive product from oxygen gas exposure. For example, U.S. Pat. No. 4,277,931 teaches that semirigid containers for packaging food products may be formed from laminates containing polyvinylidene chloride. U.S. Pat. Nos. 5,031,383; 5,058,761; and 5,558,891 disclose the use of a rubber modified acrylonitrile methyl acrylate copolymer, also known under the trademark Barex®, in the rigid food packaging containers. U.S. Pat. No. 6,408,598 teaches that a barrier layer of polyvinylidene chloride copolymer, ethylene vinyl alcohol, or polyamide may be used in forming a rigid product support member of a food packaging container.

However, there is a drawback to the prior art rigid and semirigid containers. It can be difficult to provide a thermoformed cavity in rigid and semirigid containers without undue thinning of the oxygen barrier material in the corners of the package. It is believed that this thinning in the corners of a package decreases the over-all oxygen barrier protection that would otherwise be afforded by the container. Consequently, reduced barrier protection causes abbreviated shelf-life for oxygen-sensitive products. Accordingly, the need exists to provide rigid and semirigid containers having at least one thermoformed cavity for packaging perishable food and non-food items without dilution and/or loss of barrier protection.

### SUMMARY OF THE DISCLOSURE

It has been discovered that rigid and semirigid packaging trays having a receptacle cavity prepared from a thermoplastic multilayer film comprising a first polyamide layer, an ethylene/vinyl alcohol copolymer layer, a second polyamide layer and where the ethylene/vinyl alcohol copolymer layer is positioned between the first and second polyamide layers yield a packaging article having enhanced oxygen barrier protection.

As a first aspect, the present disclosure is directed to packaging articles comprising a rigid or semirigid tray which has a receptacle cavity comprising a thermoplastic multilayer film. The receptacle cavity is integrally formed from a thermoplastic multilayer film and is defined by a bottom panel, an upstanding sidewall and a mouth. The thermoplastic multilayer film includes at least a rigid or semirigid component and an oxygen barrier component comprising a first polyamide layer, an ethylene/vinyl alcohol copolymer layer, a second polyamide layer, such that the ethylene/vinyl alcohol copolymer layer is in direct contact with both the first and second polyamide layers. It is desirable that the oxygen barrier component provides the receptacle cavity with an oxygen permeability of less than about 310 cm³/m²/24 hours at 1 atmosphere and 0% relative humidity, and preferably less than 75 cm³/m²/24 hours, and more preferably less than 20 cm³/m²/24 hours. For rigid trays, the tray has a modulus of elasticity (storage), either in flexure or in tension, greater than 700 MPa (100,000 psi) at 23° C. and 50% relative humidity. For semirigid trays, the tray has a modulus of elasticity (storage), either in flexure or in tension, of between 70-700 MPa (10,000-100,000 psi) at 23° C. and 50% relative humidity. Any suitable rigid or semirigid component may be included in the films of the present invention. The rigid and semirigid components may each include, but are not limited to, a homopolymer or copolymer of polyethylene (PE), polypropylene (PP), polyester, polystyrene (PS), polyvinylchloride (PVC), polycarbonate (PC) and blends thereof and, preferably includes a polypropylene (PP), high-density polyethylene (HDPE), cyclic olefin copolymer (COC), polyethylene terephthalate (PET), amorphous polyethylene terephthalate (APET), glycol-modified polyethylene terephthalate (PETG), polylactic acid (PLA), polystyrene (PS), high-impact polystyrene (HIPS), polyvinylchloride (PVC), polycarbonate (PC) or blends thereof. Preferably, the total amount of the rigid or semirigid component present in the thermoplastic multilayer film is at least 50% by weight relative to the film. The films of the present invention may be made by conventional processes which are modified to provide for inclusion of a rigid or semirigid component and an oxygen barrier component. Preferably, the films of the present invention include at least one coextruded film or film laminate, or both a coextruded film and a film laminate. Preferably, the thermoplastic multilayer films have a heat shrinkage value less than about 25% in the machine direction at 90° C. and less than about 25% in the transverse direction at 90° C., as measured in accordance with ASTMD-2732-96 test method.

In a second aspect, the present invention provides packaging articles comprising a rigid or semirigid tray which has a receptacle cavity comprising a thermoplastic multilayer film. The films include both oxygen barrier component and a rigid or semirigid component comprising at least one polymer layer including a material selected from the group consisting of a homopolymer or copolymer of polyethylene (PE), polypropylene (PP), polyester, polystyrene (PS), polyvinylchloride (PVC), polycarbonate (PC) and blends thereof and, preferably include polypropylene (PP), high-density polyethylene (HDPE), cyclic olefin copolymer (COC), polyethylene terephthalate (PET), amorphous polyethylene terephthalate (APET), glycol-modified polyethylene terephthalate (PETG), polylactic acid (PLA), polystyrene (PS), high-impact polystyrene (HIPS), polyvinylchloride (PVC), polycarbonate (PC) or blends thereof.

As a third aspect, the present disclosure is directed to packaging articles comprising a rigid or semirigid tray which has a receptacle cavity comprising a thermoplastic multilayer film. The films include both oxygen barrier component and a rigid or semirigid component comprising a plurality of polymer layers each having a material selected from the group consisting of a homopolymer or copolymer of polyethylene (PE), polypropylene (PP), polyester, polystyrene (PS), polyvinylchloride (PVC), polycarbonate (PC) and blends thereof and, preferably include polypropylene (PP), high-density polyethylene (HDPE), cyclic olefin copolymer (COC), polyethylene terephthalate (PET), amorphous polyethylene terephthalate (APET), glycol-modified polyethylene terephthalate (PETG), polylactic acid (PLA), polystyrene (PS), high-impact polystyrene (HIPS), polyvinylchloride (PVC), polycarbonate (PC) or blends thereof.

### BRIEF DESCRIPTION OF THE DRAWINGS

FIG. 1 shows a diagrammatic cross-sectional view of one embodiment of a tray for use in the packaging article according to the present invention.

FIG. 2 shows a diagrammatic cross-sectional view of one embodiment of the thermoplastic multilayer film suitable for use with the packaging article according to the present invention.

FIG. 3 shows a diagrammatic cross-sectional view of another embodiment of the thermoplastic multilayer film suitable for use with the packaging article according to the present invention.

### DETAILED DESCRIPTION OF THE DISCLOSURE

As used herein, the term “rigid” refers to a plastic material as defined in accordance ASTM D-883-00. A rigid plastic has a modulus of elasticity (storage), either in flexure or in tension, greater than 700 MPa (100,000 psi) at 23° C. and 50% relative humidity when tested in accordance with ASTM D-747-00, ASTM D-790-02, ASTM D-638-03 or ASTM D-882-01 test methods which are each incorporated herein by reference in their entireties. In contrast, the term “semirigid” refers to a plastic material having a modulus of elasticity (storage), either in flexure or in tension, of between 70-700 MPa (10,000-100,000 psi) at 23° C. and 50% relative humidity when tested in accordance with ASTM D-747-02, ASTM D-790-02, ASTM D-638-03 or ASTM D-882-01 test methods. In accordance with the present invention, the terms “rigid” and “semirigid” may each be used to represent any plastic and film or laminate structure and substructure thereof.

As used herein, the term “thermoplastic” refers to a polymer or polymer mixture that softens when exposed to heat and then returns to its original condition when cooled to room temperature. In general, thermoplastic materials may include natural or synthetic polymers. Thermoplastic materials may further include any polymer that is cross-linked by either radiation or chemical reaction during the manufacturing or post manufacturing process operation.

As used herein, the term “polymer” refers to a material which is the product of a polymerization or copolymerization reaction of natural, synthetic, or natural and synthetic monomers and/or comonomers, and is inclusive of homopolymers, copolymers, terpolymers, etc. In general, the layers of a film of the present invention may comprise a single polymer, a mixture of a single polymer and non-polymeric material, a combination of two or more polymer materials blended together, or a mixture of a blend of two or more polymer materials and non-polymeric material. It will be noted that many polymers may be synthesized by the mutual reaction of complementary monomers. It will also be noted that some polymers are obtained by the chemical modification of other polymers such that the structure of the macromolecules that constitute the resulting polymer can be thought of as having been formed by the homopolymerization of a hypothetical monomer.

As used herein, the term “copolymer” refers to a polymer product obtained by the polymerization reaction or copolymerization of at least two monomer species. Copolymers may also be referred to as bipolymers. The term “copolymer” is also inclusive of the polymerization reaction of three, four or more monomer species having reaction products referred to terpolymers, quaterpolymers, etc. As used herein, a copolymer identified in terms of a plurality of monomers, e.g., ethylene/propylene copolymer, refers to a copolymer in which either monomer may copolymerize in a higher weight or molar percent than the other monomer or monomers. It is appreciated by a person of ordinary skill in the art that the term “copolymer,” as used herein, refers to those copolymers where the first listed comonomer is polymerized in a higher weight percent than the second listed comonomer.

As used herein, the term “layer” refers to a discrete film component which is coextensive with the film and has a substantially uniform composition. In a monolayer film, “film” and “layer” would be one and the same.

As used herein, the term “thermoformable” refers to a polymer film which is capable of being permanently formed into a desired shape upon the application of a differential pressure between the film and a mold, by heat or a combination of a differential pressure between the film and a mold and heat, or by any thermoforming technique known to those skilled in the art.

As used herein, the term “coextruded” refers to the process of extruding two or more polymer materials through a single die with two or more orifices arranged so that the extrudates merge and weld together into a laminar structure before chilling, i.e., quenching. Thermoplastic films suitable for use in the present invention may be fabricated by any coextrusion method known to a person of ordinary skill in the art which may include, but is not limited to, for example, blown film coextrusion, slot cast coextrusion, and extrusion coating, preferably, slot cast and blown film. For example, the films may be formed by combining different streams of melt-plastified polymers into a single structure by slot or flat cast or blown bubble coextrusion. The flat die or slot cast process includes extruding polymer streams through a flat or slot die onto a chilled roll and subsequently winding the film onto a core to form a roll of film for further processing. In the blown coextrusion process, streams of melt-plastified polymers are forced through an annular die having a central mandrel to form a tubular extrudate. The tubular extrudate may be expanded to a desired wall thickness by a volume of air or other gas entering the hollow interior of the extrudate via the mandrel, and then rapidly cooled or quenched by any of various methods known to those of skill in the art. Unless otherwise noted, the thermoplastic resins utilized in the present invention are generally commercially available in pellet form and, as generally recognized in the art, may be melt blended or mechanically mixed by well-known methods using commercially available equipment including tumblers, mixers or blenders. Also, if desired, well known additives such as processing aids, slip agents, anti-blocking agents and pigments, and mixtures thereof may be incorporated into the film, by blending prior to extrusion. The resins and any additives are introduced to an extruder where the resins are melt plastified by heating and then transferred to an extrusion (or coextrusion) die for formation into a tube. Extruder and die temperatures will generally depend upon the particular resin or resin containing mixtures being processed and suitable temperature ranges for commercially available resins are generally known in the art, or are provided in technical bulletins made available by resin manufacturers. Processing temperatures may vary depending upon other processing parameters chosen.

The term “oxygen barrier” refers to any polymer film that can retard the transmission oxygen gas. It is appreciated by a person of ordinary skill in the art that a desirable oxygen barrier property is one which provides a substrate, i.e., film or laminate with a steady-state oxygen transmission rate of between 0-15.5 cm³/m²/24 hours at 23° C., 80% R.H. and 1 atmosphere (atm). The steady-state gas transmission rate may be measured through parallel surfaces of a unit area per unit time at a specified temperature, relative humidity and partial pressure in accordance with ASTM D-3985-02 test method. Steady-state oxygen transmission rates determined in this manner may be obtained by using an OX-TRAN® Oxygen Transmission Rate Tester Model 2/20 and 2/21 available from Mocon, Inc., Minneapolis, Minn., U.S.A.

The phrase “heat shrinkage” as discussed herein is defined as the unrestrained heat shrink of a film determined at 90° C. for five seconds. In general, the heat shrinkage values are obtained for four test specimens by cutting each film sample to 10 cm in the machine direction by 10 cm in the transverse direction. Each specimen is completely immersed for 5 seconds in a 90° C. water bath (or other specified non-reactive liquid). The distance between the ends of the shrunken specimen is measured. The difference in the measured distance for the shrunken specimen and the original 10 cm is multiplied by ten to obtain the percent of shrinkage for the specimen for each direction. The machine direction shrinkage for the four specimens is averaged for the machine direction shrinkage value of the given film sample, and the transverse direction shrinkage for the four specimens is averaged for the transverse direction shrinkage value. Heat shrinkage values may be determined in accordance with ASTM D-2732-96 test method which is incorporated herein by reference.

As used herein, the phrase “direct contact with and bonded to” as applied to film layers of the present invention, defines a subject film layer having face-to-face contact to another film layer (presumably, over their entire planar surfaces).

As used herein, terminology employing a “/” with respect to the chemical identity of any copolymer, e.g., an ethylene/unsaturated ester copolymer, identifies the comonomers which are copolymerized to produce the copolymer.

As used herein, the term “alkyl” as used herein, may refer to any aliphatic or aromatic (or aryl) structural moieties and combinations thereof as generally understood by those skilled in the art.

As used herein, the terms “polyamide” and “nylon” are used synonymously herein and refer to a homopolymer or copolymer having an amide linkage between monomer units which may be formed by any method known to those skilled in the art. The amide linkage can be represented by the general formula: [C(O)—R—C(O)—NH—R′—NH]ₙ where R and R′=the same or different alkyl (or aryl) group. Examples of nylon polymers include, but are not limited to, nylon 6 (polycaprolactam), nylon 11 (polyundecanolactam), nylon 12 (polyauryllactam), nylon 4,2 (polytetramethylene ethylenediamide), nylon 4,6 (polytetramethylene adipamide), nylon 6,6 (polyhexamethylene adipamide), nylon 6,9 (polyhexamethylene azelamide), nylon 6,10 (polyhexamethylene sebacamide), nylon 6,12 (polyhexamethylene dodecanediamide), nylon 7,7 (polyheptamethylene pimelamide), nylon 8,8 (polyoctamethylene suberamide), nylon 9,9 (polynonamethylene azelamide), nylon 10,9 (polydecamethylene azelamide), nylon 12,12 (polydodecamethylene dodecanediamide), and the like. Examples of nylon copolymers include, but are not limited to, nylon 6,6/6 copolymer (polyhexamethylene adipamide/caprolactam copolymer), nylon 6,6/9 copolymer (polyhexamethylene adipamide/azelaiamide copolymer), nylon 6/6,6 copolymer (polycaprolactam/hexamethylene adipamide copolymer), nylon 6,2/6,2 copolymer (polyhexamethylene ethylenediamide/hexamethylene ethylenediamide copolymer), nylon 6,6/6,9/6 copolymer (polyhexamethylene adipamide/hexamethylene azelaiamide/caprolactam copolymer), as well as other nylons which are not particularly delineated here. Exemplary of aromatic nylon polymers include, but are not limited to, nylon 4,I, nylon 6,I, nylon 6,6/6I copolymer, nylon 6,6/6T copolymer, nylon MXD6 (poly-m-xylylene adipamide), poly-p-xylylene adipamide, nylon 6I/6T copolymer, nylon 6T/6I copolymer, nylon MXDI, nylon 6/MXDT/I copolymer, nylon 6T (polyhexamethylene terephthalamide), nylon 12T (polydodecamethylene terephthalamide), nylon 66T, nylon 6-3-T (poly(trimethyl hexamethylene terephthalamide).

As used herein, the phrase “ethylene/vinyl alcohol copolymer” (EVOH), refers to copolymers composed of repeating units of ethylene and vinyl alcohol. Ethylene/vinyl alcohol copolymers can be represented by the general formula: [(CH₂—CH₂)ₘ—(CH₂—CH(OH))]ₙ. Ethylene/vinyl alcohol copolymers may include saponified or hydrolyzed ethylene/vinyl acrylate copolymers, and refers to a vinyl alcohol copolymer having an ethylene comonomer, and prepared by, for example, hydrolysis of vinyl acrylate copolymers or by chemical reactions with vinyl alcohol. The degree of hydrolysis is preferably at least 50%, and more preferably, at least 85%. Preferably, ethylene/vinyl alcohol copolymers comprise from about 28-48 mole % ethylene, more preferably, from about 32-44 mole % ethylene, and even more preferably, from about 38-44 mole % ethylene. Non-limiting examples of ethylene/vinyl alcohol copolymers include the family of EVOH sold under the trademark SOARNOL® from Nippon Gohsei, Tokyo, Japan.

As used herein, the term “polypropylene” refers to a homopolymer or copolymer having at least one propylene monomer linkage within the repeating backbone of the polymer. The propylene linkage can be represented by the general formula: [CH₂—CH(CH3)]ₙ.

As used herein, the term “polyester” refers to a homopolymer or copolymer having an ester linkage between monomer units which may be formed, for example, by condensation polymerization reactions between a dicarboxylic acid and a diol. The ester linkage can be represented by the general formula: [O—R—OC(O)—R′—C(O)]ₙ where R and R′=the same or different alkyl (or aryl) group and may be generally formed from the polymerization of dicarboxylic acid and diol monomers containing both carboxylic acid and hydroxyl moieties. The dicarboxylic acid may be linear or aliphatic, i.e., lactic acid, oxalic acid, maleic acid, succinic acid, glutaric acid, adipic acid, pimelic acid, suberic acid, azelaic acid, sebacic acid, and the like; or may be aromatic or alkyl substituted aromatic, i.e., various isomers of phthalic acid, such as paraphthalic acid (or terephthalic acid), isophthalic acid and naphthalic acid. Specific examples a useful diol include, but not limited to, ethylene glycol, propylene glycol, trimethylene glycol, 1,4-butane diol, neopentyl glycol, cyclohexane diol and the like. Suitable polyesters may include, a homopolymer or copolymer of alkyl-aromatic esters, such as, for example, but not limited to, polyethylene terephthalate (PET), amorphous polyethylene terephthalate (APET), crystalline polyethylene terephthalate (CPET), glycol-modified polyethylene terephthalate (PETG), and polybutylene terephthalate; copolymers of terephthalate and isophthalate, such as, for example, but not limited to, polyethylene terephthalate/isophthalate copolymer; and a homopolymer or copolymer of aliphatic esters such as, for example, polylactic acid (PLA) and polyhydroxyalkonates, such as, for example, but not limited to, polyhydroxypropionate, poly(3-hydroxybutyrate) (PH3B), poly(3-hydroxyvalerate) (PH3V), poly(4-hydroxybutyrate) (PH4B), poly(4-hydroxyvalerate) (PH4V), poly(5-hydroxyvalerate) (PH5V), poly(6-hydroxydodecanoate) (PH6D) and blends of any of these materials.

As used herein, the term “polystyrene” refers to a homopolymer or copolymer having at least one styrene monomer (benzene, i.e., C₆H₅, having an ethylene substituent) linkage within the repeating backbone of the polymer. The styrene linkage can be represented by the general formula: [CH₂—CH₂(C₆H₅)]ₙ. Polystyrene may be formed by any method known to those skilled in the art. Suitable polystyrenes include, for example, but are not limited to, oriented polystyrene (OPS) film and resins, i.e., polystyrene (PS), syndiotactic polystyrene (SPS), acrylonitrile-butadiene-styrene (ABS), styrene-acrylonitrile (SAN), ethylene/styrene copolymers, styrene/acrylic copolymers, styrene block copolymers (SBC), and the like. Other non-limiting examples of polystyrene suitable for use in the present invention include high-impact polystyrene (HIPS).

As used herein, the term “polyethylene” refers to a homopolymer or copolymer having at least one ethylene monomer linkage within the repeating backbone of the polymer. The ethylene linkage can be represented by the general formula: [CH2—CH2]ₙ. Polyethylenes (PE) may be formed by any method known to those skilled in the art. Suitable polyethylenes may include, but is not limited to, high-density polyethylene (HDPE), ultra high-density polyethylene (UHDPE), and cyclic olefin copolymers (COC). Exemplary of commercially available cyclic olefin copolymers suitable for use in the present invention include, but are not limited to, the TOPAS® family of resins which is supplied by Celanese-Ticona, Summit, N.J., U.S.A.

As used herein, the term “polyvinylchloride” refers to a homopolymer or copolymer having at least one vinyl chloride monomer linkage, i.e., ethylene moiety having a chlorine atom substituent on a carbon atom, within the repeating backbone of the polymer. Polyvinylchloride (PVC) can be represented by the general formula: [CH₂—CH(Cl)]ₙ.

As used herein, the term “polycarbonate” refers to a homopolymer or copolymer having at least one carbonate monomer linkage within the repeating backbone of the polymer. Polycarbonate (PC) can be represented by the general formula: [O—R—OC(O)]ₙ.

As used herein, the terms “comprise”, “include” and grammatical variations thereof are to be taken to specify the presence of stated features, integers, steps or components or groups thereof, but do not preclude the presence or addition of one or more other features, integers, steps, components or groups thereof.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout.

### EXAMPLES

It is to be understood, the present invention is not restricted to the following examples within the scope of the invention.

### Packaging Example 1

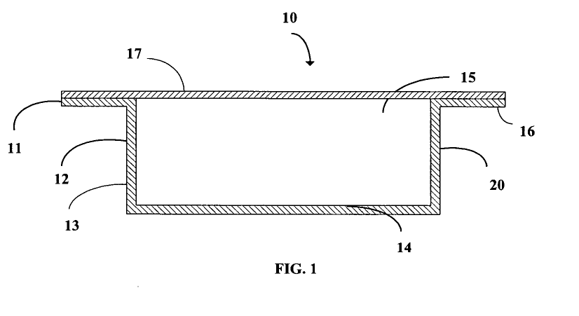

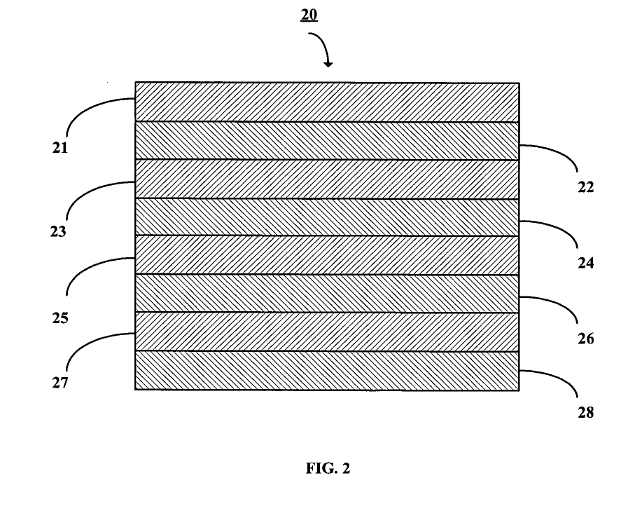

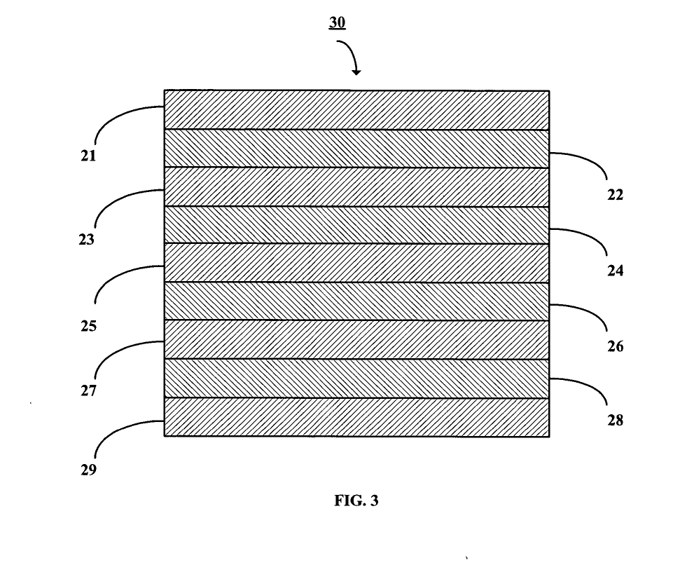

FIG. 1 illustrates packaging article 10 which represents one example of the present invention. As depicted, packaging article 10 includes a rigid tray 11 having a cup-like shaped receptacle cavity 12 to support a product (not shown) which is formed from a thermoplastic film 20 (see also FIGS. 2-3). One skilled in the art will appreciate that rigid tray 11 may include any number of receptacle cavities in any desired configuration or shape, e.g., rectangular, round, oval, etc., depending upon the number, size and shape of the product packaged therein. As illustrated in FIG. 1, rigid tray 11 includes a single receptacle cavity 12 having a cup-like shape with a diameter of approximately 4.5 in (11.4 cm) and is defined by upstanding sidewall 13, a bottom panel 14 and mouth 15. Receptacle cavity 12 has a draw depth of approximately 1.62 in (4.12 cm). Preferably, receptacle cavity 12 has a draw depth of at least 0.250 in (0.635 cm), more preferably, between 0.250-10.00 in (0.635-25.4 cm), and most preferably, between 0.250-5.00 in (0.635-12.7 cm). This example illustrates rigid tray 11 having a peripheral flange 16 extending outwardly from receptacle cavity 12 thereby delineating the outermost edges of packaging article 10. It will also be appreciated that packaging article 10 may include a rigid tray 11 having peripheral flange 16 and bottom panel 14 which are both monolithically formed from the same thermoplastic film 20. Packaging article 10 may further include a lid 17 which covers mouth 15 of receptacle cavity 12 and thereby enclose a product (not shown) contained therein. Lid 17 may be adhesively or thermally affixed to peripheral flange 16 of the container. Lid 17 may further be peelably affixed to peripheral flange 16 of the container. A hermetically sealed packaged product may be formed when a food or non-food item is placed inside receptacle cavity 12 and lid 17 is attached to packaging article 10.

### Film Examples 2-3

Film Examples 2-3 represent an eight-layer embodiment of thermoplastic film 20 according to the present invention and are illustrated in FIG. 2. In Film Examples 2-3, film 20 includes a first polymer layer 21, a second polymer layer 22, a third polymer layer 23, a fourth polymer layer 24, a fifth polymer layer 25, a sixth polymer layer 26, a seventh polymer layer 27, and an eighth polymer layer 28. First polymer layer 21 comprised 100% (by weight relative to the total weight of the first layer) glycol-modified polyethylene terephthalate (PETG). The glycol-modified polyethylene terephthalate has a glass transition temperature of 80° C., a reported crystalline density of about 1.27 g/cm³, a Vicat softening temperature of 85° C. and is sold under the trademark EASTAR™ COPOLYESTER 6763 from Eastman Chemical Company, Kingsport, Tenn., U.S.A. First polymer layer 21 had a thickness of about 13 mil (330 mm). Second polymer layer 22 included 94.5% (by weight relative to the total weight of the second polymer layer) polyethylene terephthalate copolymer (PET) and 5.5% (by weight relative to the total weight of the second polymer layer) processing additives. The polyethylene terephthalate copolymer has a reported crystalline density of 1.4 g/cm³ and crystalline peak melting point of 240° C., and is sold under the tradename VORIDIAN PET 9921 from Eastman Chemical Company, Kingsport, Tenn., U.S.A. Second polymer layer 22 had a thickness of about 0.72 mil (18 mm). Layers 23 and 27, the third and seventh polymer layers, respectively, each included an adhesive (tie) material comprising 60% (by weight relative to the total weight of either polymer layer) ethylene/methacrylate copolymer (EMA) having methyl acrylate content of 22%, a density of 0.948 g/cm³, a melt index of 2.0 g/10 min, being available under the product name EMAC+SP1330™ from Eastman Chemical Company, Kingsport, Tenn., U.S.A., 10% (by weight relative to the total weight of either polymer layer) of anhydride-modified linear low density polyethylene (m-LLDPE) having a density of 0.91 g/cm³, melt flow index of 2.7 g/10 minutes, a melting point of 115° C., a Vicat softening point of 103° C. and sold under the trademark BYNEL® 41E710 which is available from E.I. de Pont de Nemours and Company, Wilmington, Del., U.S.A., and 30% (by weight relative to the total weight of either polymer layer) polyethylene (PE) having a density of 0.918 g/cm³, a melt index of 1.0 g/10 min, and a melting point of 120° C., sold under the product name ESCORENE LL 1001™ and obtained from ExxonMobil Chemical Company of Houston, Tex., U.S.A. Third and seventh polymer layers, 23 and 27, had a thickness of about 0.44 mil (11 mm) and about 0.40 mil (10 mm), respectively. Fourth and sixth polymer layers, 24 and 26, included an identical nylon blend of 85% (by weight relative to the total weight of either polymer layer) nylon 6 having a density of 1.12 g/cm³, a melting point of a 220° C., a recrystallization temperature (as measured by deferential scanning calorimetry (DSC)) of 176° C., was available under the trademark ULTRAMID™ B36 from BASF Corporation, Mount Olive, N.J., U.S.A.; and 15% (by weight relative to the total weight of the either polymer layer) an aromatic nylon having a density of 1.19 g/cm³, a glass transition temperature of 127° C., a heat deflection temperature at 66 psi of 126° C., and was sold under the trademark DUPONT SELAR® PA 3426 by E.I. de Pont de Nemours and Company, Wilmington, Del., U.S.A. DUPONT SELAR® PA 3426 is an aromatic polyamide, nylon 6I/6T, which is manufactured from the condensation of hexamethylenediamine, terephthalic acid, and isophthalic acid such that 65-80% of the polymer repeating unit is derived from hexamethylene isophthalamide. Fourth and sixth polymer layers, 24 and 26, each had a thickness of about 0.40 mil (10 mm). Fifth polymer layer 25 included an oxygen barrier material comprising 100% (weight relative to the total weight of the fifth polymer layer) ethylene/vinyl alcohol copolymer (EVOH) having a 38 mol % ethylene content, a reported density of 1.17 g/cm³, a melting point of between 172-173° C., such as that sold under the trademark SOARNOL™ ET3803 which is available from the Nippon Synthetic Chemical Industry Company, Ltd. (Nippon Gohsei), Osaka, Japan and EVAL™ H171 which is available from Kuraray Company, Ltd., Osaka, Japan. Fifth polymer layer had a thickness of 0.72 mil (18.29 mm). Eighth polymer layer 28 included a sealant material of 98.20% (by weight relative to the total weight of the eighth layer) of ultra low-density polyethylene and 1.80% (by weight relative to the total weight of the eighth layer) processing additives. The ultra low-density polyethylene (ULDPE) had a melt index of 1 g/10 min, a density of 0.912 g/cm³, a melting point of 123° C., a Vicat softening point of 93° C., which is sold under the trademark ATTANE® 4201G by The Dow Chemical Company, Midland, Mich., U.S.A. In Example 2, film 20 was formed by coextruding polymer layers 22-28 and subsequently, extrusion coating polymer layer 21 onto these layers. It will be appreciated that fifth polymer layer 25 is in direct contact with and bond to both fourth polymer layer 24 and sixth polymer layer 26. Polymer layers 22-28 may be formed any coextrusion method known to those skilled in the art. Film 20 of Example 2 had a total thickness of about 17 mil (432 mm). It will be noted that for Film Example 2, all polymer layer thicknesses were measured prior to thermoforming.

Film Example 3 is an alternative eight-layer embodiment of film 20 and is represented in FIG. 2. In Film Example 3, polymer layers 21-28 may have the same layer configuration and composition as described for Example 2 with the exception that polymer layers, 21 and 28, each comprise 100% (by weight relative to the total weight of the either polymer layer) glycol-modified polyethylene terephthalate (PETG). In this example, polymer layers, 21 and 28, may each have a thickness of between about 6-7 mil (152-178 mm). Film 20 may have a total thickness of between 16-17 mil (406-432 mm).

Film Example 4, is illustrated in FIG. 3, and represents a nine-layer thermoplastic film 30. Film 30 may also be used to form rigid or semirigid tray 11 of packaging article 10 as depicted in FIG. 1. Film 30 may comprise nine polymer layers, 21-29 such that layers 21-28 have an identical layer configuration and composition as that of layers 21-28 of film 20 in Example 3. Polymer layer 29 may include a sealant material such as that described for layer 28 of film 20 in Example 2 (see FIG. 2). In this example, polymer layers 21 and 28, may each have a thickness of between about 6-7 mil (152-178 mm). Film 30 may have a total thickness of between 16-17 mil (406-432 mm).

### Comparative Film Example

Comparative Film Example 5 represents an eight-layer thermoplastic film which may be illustrated as film 20 (see FIG. 2). In Example 5, comparative film 20 included a first polymer layer 21 comprised of 100% (by weight relative to the total weight of the first layer) glycol-modified polyethylene terephthalate (PETG) having a glass transition temperature of 80° C., a reported crystalline density of about 1.27 g/cm³, a Vicat softening temperature of 85° C. and having a thickness of about 10 mil (254 mm); a second polymer layer 22 comprised of 61% (by weight relative to the second polymer layer) ethylene/vinyl acetate copolymer (EVA) having 28% (by weight) vinyl acetate content, a density of 0.95 g/cm³, a melt index of 3 g/10 min a Vicat softening point of 49° C. which is sold under the trademark DUPONT™ ELVAX® 3182 by E.I. de Pont de Nemours and Company, Wilmington, Del., U.S.A., 35% (by weight relative to the second polymer layer) butene linear low-density polyethylene having a density of 0.918 g/cm³, a melt index of 1 g/10 min, a peak melting temperature of 121° C., which is available under the tradename EXXONMOBIL LLDPE LL1001.32 from ExxonMobil Chemical Company, Inc., Houston, Tex., U.S.A., 4% (by weight relative to the second polymer layer) process additives, and having a thickness of approximately 0.59 mil (15 mm); a third polymer layer 23 comprising 100% (by weight relative to the third polymer layer) ultra low-density polyethylene (ULDPE) having a melt index of 1 g/10 min, a density of 0.912 g/cm³, a melting point of 123° C., a Vicat softening point of 93° C., and having a thickness of approximately 0.31 mil (7.9 mm); a fourth polymer layer 24 comprising 100% (by weight relative to the fourth polymer layer) anhydride-modified linear low density polyethylene (m-LLDPE) having a density of 0.91 g/cm³, melt flow index of 2.7 g/10 minutes, a melting point of 115° C., a Vicat softening point of 103° C. and having a thickness of about 0.15 mil (3.8 mm); a fifth polymer layer 25 comprising 100% (by weight relative to the fifth polymer layer) ethylene/vinyl alcohol copolymer (EVOH) having a 38 mol % ethylene content, a reported density of 1.17 g/cm³, a melting point of between 172-173° C. and having a thickness of about 0.30 mil (7.6 mm); a sixth polymer layer 26 having an identical composition as fourth polymer layer 24 and a thickness of approximately 0.25 mil (6.35 mm); a seventh polymer layer 27 comprising of 81% (by weight relative to the seventh polymer layer) ethylene/vinyl acetate copolymer (EVA) having 5% (by weight) vinyl acetate content, a melt index of 1.5 g/10 min a Vicat softening point of 88° C. which is sold under the trademark PETROTHENE NA 442 by Lyondell Chemical Company, Inc., Houston, Tex., U.S.A., 19% (by weight relative to the seventh polymer layer) of polybutene copolymer having a density of 0.908 g/cm³, a melt index of 1.0 g/10 min, and a melting point of 117.2° C. obtained from Basell North America, Inc., Elkton, Md., U.S.A., and having a thickness of about 0.30 mil (7.62 mm); and a eighth polymer layer 28 comprising 97% (by weight relative to the eighth polymer layer) ethylene/vinyl acetate copolymer (EVA) having 5% (by weight) vinyl acetate content, a melt index of 1.5 g/10 min a Vicat softening point of 88° C., 3% (by weight relative to the eighth polymer layer) processing additives and having a thickness of about 0.10 mil (2.54 mm). Film 20 in Comparative Example 5 had a total thickness of about 12 mil (304.8 mm). It will be noted that for Comparative Film Example 5, all polymer layer thicknesses were measured prior to thermoforming.

Film 20 of Example 2 and Comparative Film Example 5 were each used to form package 10 as described in Packaging Example 1. Each package contained an identical processed meat product and was hermetically sealed and subjected to a Self-life Test. The Self-life Test measures, inter alias, the quality of the packaged food product as a function of time. In this test, any change in color, e.g., for processed bologna, a color change from a pink hue to a pale pink or gray hue may be observed, of the packaged meat was an indication of product quality deterioration. Generally, a color change of the meat product may occur at any location on the product and is observed typically at the edges of the product. Self-life Test results for a package formed from film 20 of Example 2 and Comparative Film Example are illustrated in Table 1. The “+” sign represents no color change to the packaged food product was observed, while the “−” sign indicates a color change was observed.

TABLE 1
Shelf-Life (in Hours) of Food Product in Sealed Package

| | Film Structure | | | | | | | |
|---|---|---|---|---|---|---|---|---|
| | 24 | 36 | 48 | 96 | 96 | 360 | 720 | 1440 |
| Comparative | + | + | + | − | − | − | − | − |
| Example 5 | | | | | | | | |
| Example 2 | + | + | + | + | + | + | + | + |

It is contemplated that the present invention may further include alternative film Examples 6-12 as shown in Table 2 below.

TABLE 2
Alternative Thermoplastic Multilayer Film Structures

| | No. | | | | | | | | | |
|---|---|---|---|---|---|---|---|---|---|---|
| | Layers | First | Second | Third | Fourth | Fifth | Sixth | Seventh | Eighth | Ninth |
| | [total | Layer (% | Layer (% | Layer (% | Layer (% | Layer (% | Layer (% | Layer (% | Layer (% | Layer (% |
| Example | thickness] | thickness) | thickness) | thickness) | thickness) | thickness) | thickness) | thickness) | thickness) | thickness) |
| 6 | 8 | HIPS | PE | Tie | Nylon | EVOH | Nylon | Tie | Ionomer | N/A |
| | [42 mil] | (95.25%) | (1.00%) | (0.57%) | (0.57%) | (0.71%) | (0.57%) | (0.57%) | (0.76%) | |
| 7 | 8 | PETG | PE | Tie | Nylon | EVOH | Nylon | Tie | EVA | N/A |
| | [5.5 mil] | (72.73%) | (4.36%) | (2.73%) | (4.36%) | (4.91%) | (4.36%) | (2.73%) | (3.82%) | |
| 8 | 9 | APET | Tie | Nylon | EVOH | Nylon | Tie | APET | Tie | PE |
| | [8 mil] | (25%) | (8%) | (5%) | (7%) | (5%) | (8%) | (25%) | (8%) | (9%) |
| 9 | 8 | PVC | PE | Tie | Nylon | EVOH | Nylon | Tie | PE | N/A |
| | [23 mil] | (86.96%) | (0.60%) | (0.39%) | (0.26%) | (0.31%) | (0.26%) | (0.39%) | (0.39%) | |
| 10 | 7 | APET | Tie | Nylon | EVOH | Nylon | Tie | APET | N/A | N/A |
| | [16 mil] | (35%) | (7%) | (5%) | (6%) | (5%) | (7%) | (35%) | | |
| 11 | 8 | APET | APET | Tie | Nylon | EVOH | Nylon | Tie | PE | N/A |
| | [16 mil] | (68.76%) | (4.69%) | (3.43%) | (2.81%) | (5.62%) | (2.81%) | (4.38%) | (7.50%) | |
| 12 | 9 | PP | Tie | Nylon | EVOH | Nylon | Tie | PP | Tie | PE |
| | [10 mil] | (25%) | (8%) | (5%) | (8%) | (5%) | (8%) | (25%) | (8%) | (8%) |

In Example 6, the second through eighth layers may be coextruded as a 2-mil blown film and a first layer of a 40 mil sheet of APET may then be laminated to the seven-layer blown film.
In Example 7, the second through eighth layers may be coextruded as a 1.5-mil blown film and a first layer of a 4 mil sheet of PETG may then be coated for thermal lamination onto the seven-layer blown film.
In Example 8, the first through ninth layers may be coextruded as an 8-mil blown film.
In Example 9, the second through eighth layers may be coextruded as a 3-mil blown film and the first layer of a 20-mil sheet of PVC may be adhesively laminated to the seven-layer blown film.
In Example 10, the first through seventh layers may be coextruded from a flat die as a 16-mil sheet.
In Example 11, the second through eighth layers may be coextruded as a 3-mil blown film, and this seven-layer film may then be thermally laminated to a first layer of an 11-mil sheet of APET.
In Example 12, the first through ninth layers may be coextruded as a 10-mil blown film.

Unless otherwise noted, the physical properties and performance characteristics reported herein were measured by test procedures similar to the following methods. The following ASTM test procedures and documents are incorporated herein by reference in their entireties:

Density of Plastics by the Density-Gradient Technique (Density): ASTM D-1505.

Flow Rates of Thermoplastics by Extrusion Plastometer (Melt Index): ASTM D-1238.

Haze and Luminous Transmittance of Transparent Plastics (Haze): ASTM D-1003-00.

Oxygen Gas Transmission Rate Through Plastic Film and Sheeting Using a Coulometric Sensor (Oxygen Transmission): ASTM D-3985-02.

Standard Test Method for Apparent Bending Modulus of Plastics by Means of a Cantilever Beam (Modulus of Elasticity): ASTM D-747-02.

Standard Test Methods for Flexural Properties of Unreinforced and Reinforced Plastics and

Electrical Insulating Materials (Modulus of Elasticity): ASTM D-790-02.

Standard Test Method for Tensile Properties of Plastics (Modulus of Elasticity): ASTM D-638-03.

Standard Test Method for Tensile Properties of Thin Plastic Sheeting (Modulus of Elasticity): ASTM D-882-01.

Standard Terminology Relating to Plastics: ASTM D-883-00.

Transition Temperatures of Polymers by Thermal Analysis (Melting Point): ASTM D-3418-03.

Vicat Softening Temperature of Plastics (Vicat Softening Point): ASTM D-1525.

Unrestrained Linear Thermal Shrinkage of Plastic Film and Sheeting (Heat Shrinkage): ASTM D-2732-96.

While various embodiments of the disclosure are herein described, it is envisioned that those skilled in the art may devise various modifications and equivalents without departing from the spirit and scope of the disclosure. The disclosure is not intended to be limited by the foregoing detailed description.

What is claimed is:

1. A packaging article comprising:
(a) a rigid or semirigid tray having a receptacle cavity and comprising a thermoplastic multilayer film;
(b) wherein said receptacle cavity is integrally formed from said film and defined by a bottom panel, a upstanding sidewall and a mouth;
(c) wherein said film comprises a rigid or semirigid component and an oxygen barrier component; wherein said oxygen barrier component comprises:
(i) a first polyamide layer,
(ii) an ethylene/vinyl alcohol copolymer layer,
(iii) a second polyamide layer,
(iv) wherein said ethylene/vinyl alcohol copolymer layer is in direct contact with and bonded to both said first and second polyamide layers.

2. The packaging article according to claim 1, wherein said tray has a modulus of elasticity (storage), either in flexure or in tension, of between 70-700 MPa (10,000-100,000 psi) at 23° C. and 50% relative humidity.

3. The packaging article according to claim 1, wherein said tray has a modulus of elasticity (storage), either in flexure or in tension, greater than 700 MPa (100,000 psi) at 23° C. and 50% relative humidity.

4. The packaging article according to claim 1, wherein said rigid or semirigid component includes at least one polymer layer comprising a material selected from the group consisting of a homopolymer or copolymer of polyethylene (PE), polypropylene (PP), polyester, polystyrene (PS), polyvinylchloride (PVC), polycarbonate (PC) and blends thereof.

5. The packaging article according to claim 4, wherein said rigid or semirigid component comprises a material selected from the group consisting of a homopolymer or copolymer of polypropylene (PP), high-density polyethylene (HDPE), cyclic olefin copolymer (COC), polyethylene terephthalate (PET), amorphous polyethylene terephthalate (APET), glycol-modified polyethylene terephthalate (PETG), polylactic acid (PLA), polystyrene (PS), high-impact polystyrene (HIPS), polyvinylchloride (PVC), polycarbonate (PC) and blends thereof.

6. The packaging article according to claim 1, wherein the total amount of said rigid or semirigid component present in said multilayer film is at least 50% by weight relative to said film.

7. The packaging article according to claim 1, wherein said rigid or semirigid component includes a plurality of polymer layers comprising a material selected from the group consisting of a homopolymer or copolymer of polyethylene (PE), polypropylene (PP), polyester, polystyrene (PS), polyvinylchloride (PVC), polycarbonate (PC) and blends thereof.

8. The packaging article according to claim 7, wherein said rigid or semirigid component includes a plurality of polymer layers each comprising a material selected from the group consisting of a homopolymer or copolymer of polypropylene (PP), high-density polyethylene (HDPE), cyclic olefin copolymer (COC), polyethylene terephthalate (PET), amorphous polyethylene terephthalate (APET), glycol-modified polyethylene terephthalate (PETG), polylactic acid (PLA), polystyrene (PS), high-impact polystyrene (HIPS), polyvinylchloride (PVC), polycarbonate (PC) and blends thereof.

9. The packaging article according to claim 8, wherein the total amount of said rigid or semirigid component present in said multilayer film is at least 50% by weight relative to said film.

10. The packaging article according to claim 1, wherein said film having a heat shrinkage value less than about 25% in the machine direction at 90° C. and less than about 25% in the transverse direction at 90° C., as measured in accordance with ASTMD-2732-96 test method.

11. The packaging article according to claim 1, wherein said film includes at least one coextruded film or film laminate.

12. The packaging article according to claim 1, wherein said film includes both a coextruded film and a film laminate.

13. The packaging article according to claim 1, wherein said receptacle cavity has a draw depth of at least 0.250 in (0.635 cm).

14. The packaging article according to claim 13, wherein said receptacle cavity has a draw depth of between 0.250-10.00 in (0.635-25.4 cm).

15. The packaging article according to claim 1, wherein said article further comprises a lid which covers said mouth of said cavity to hermetically enclose a product therein.

16. A packaging article comprising:
(a) a rigid or semirigid tray having a receptacle cavity and comprising a thermoplastic multilayer film;
(b) wherein said receptacle cavity is integrally formed from said film and is defined by a bottom panel, a upstanding sidewall and a mouth; and
(c) wherein said film comprises a rigid or semirigid component and an oxygen barrier component; wherein said oxygen barrier component comprises:
(i) a first polyamide layer,
(ii) an ethylene/vinyl alcohol copolymer layer,
(iii) a second polyamide layer,
(iv) wherein said ethylene/vinyl alcohol copolymer layer is in direct contact with and bonded to both said first and second polyamide layers,
(d) wherein said rigid or semirigid component includes at least one polymer layer comprising a material selected from the group consisting of a homopolymer or copolymer of polyethylene (PE), polypropylene (PP), polyester, polystyrene (PS), polyvinylchloride (PVC), polycarbonate (PC) and blends thereof.

17. The packaging article according to claim 16, wherein said rigid or semirigid component comprises a material selected from the group consisting of a homopolymer or copolymer of polypropylene (PP), high-density polyethylene (HDPE), cyclic olefin copolymer (COC), polyethylene terephthalate (PET), amorphous polyethylene terephthalate (APET), glycol-modified polyethylene terephthalate (PETG), polylactic acid (PLA), polystyrene (PS), high-impact polystyrene (HIPS), polyvinylchloride (PVC), polycarbonate (PC) and blends thereof.

18. The packaging article according to claim 16, wherein said tray has a modulus of elasticity (storage), either in flexure or in tension, of between 70-700 MPa (10,000-100,000 psi) at 23° C. and 50% relative humidity.

19. The packaging article according to claim 16, wherein said tray has a modulus of elasticity (storage), either in flexure or in tension, greater than 700 MPa (100,000 psi) at 23° C. and 50% relative humidity.

20. The packaging article according to claim 16, wherein the total amount of said rigid or semirigid component present in said film is at least 50% by weight relative to said film.

21. The packaging article according to claim 16, wherein said film has a heat shrinkage value less than about 25% in the machine direction at 90° C. and less than about 25% in the transverse direction at 90° C., as measured in accordance with ASTMD-2732-96 test method.

22. The packaging article according to claim 16, wherein said film includes at least one coextruded film or film laminate.

23. The packaging article according to claim 16, wherein said film includes both a coextruded film and a film laminate.

24. The packaging article according to claim 16, wherein said receptacle cavity has a draw depth of at least 0.250 in (0.635 cm).

25. The packaging article according to claim 24, wherein said receptacle cavity has a draw depth of between 0.250-10.00 in (0.635-25.4 cm).

26. The packaging article according to claim 16, wherein said article further comprises a lid which covers said mouth of said cavity to hermetically enclose a product therein.

27. The packaging article according to claim 16, wherein said rigid or semirigid component includes a plurality of polymer layers each comprising a material selected from the group consisting of a homopolymer or copolymer of polyethylene (PE), polypropylene (PP), polyester, polystyrene (PS), polyvinylchloride (PVC), polycarbonate (PC) and blends thereof.

28. The packaging article according to claim 27, wherein said rigid or semirigid component comprises a material selected from the group consisting of a homopolymer or copolymer of polypropylene (PP), high-density polyethylene (HDPE), cyclic olefin copolymer (COC), polyethylene terephthalate (PET), amorphous polyethylene terephthalate (APET), glycol-modified polyethylene terephthalate (PETG), polylactic acid (PLA), polystyrene (PS), high-impact polystyrene (HIPS), polyvinylchloride (PVC), polycarbonate (PC) and blends thereof.

29. A packaging article comprising:
(a) a rigid or semirigid tray having a receptacle cavity and comprising a thermoplastic multilayer film;
(b) wherein said receptacle cavity is integrally formed from said film and is defined by a bottom panel, a upstanding sidewall and a mouth; and
(c) wherein said film comprises a rigid or semirigid component and an oxygen barrier component; wherein said oxygen barrier component comprises:
(i) a first polyamide layer,
(ii) an ethylene/vinyl alcohol copolymer layer,
(iii) a second polyamide layer,
(iv) wherein said ethylene/vinyl alcohol copolymer layer is in direct contact with and bonded to both said first and second polyamide layers,
(d) wherein said rigid or semirigid component includes a plurality of polymer layers each comprising a material selected from the group consisting of a homopolymer or copolymer of polyethylene (PE), polypropylene (PP), polyester, polystyrene (PS), polyvinylchloride (PVC), polycarbonate (PC) and blends thereof.

30. The packaging article according to claim 29, wherein said rigid or semirigid component comprises a material selected from the group consisting of a homopolymer or copolymer of polypropylene (PP), high-density polyethylene (HDPE), cyclic olefin copolymer (COC), polyethylene terephthalate (PET), amorphous polyethylene terephthalate (APET), glycol-modified polyethylene terephthalate (PETG), polylactic acid (PLA), polystyrene (PS), high-impact polystyrene (HIPS), polyvinylchloride (PVC), polycarbonate (PC) and blends thereof.

31. The packaging article according to claim 29, wherein said tray has a modulus of elasticity (storage), either in flexure or in tension, of between 70-700 MPa (10,000-100,000 psi) at 23° C. and 50% relative humidity.

32. The packaging article according to claim 29, wherein said tray has a modulus of elasticity (storage), either in flexure or in tension, greater than 700 MPa (100,000 psi) at 23° C. and 50% relative humidity.

33. The packaging article according to claim 29, wherein the total amount of said rigid or semirigid component present in said film is at least 50% by weight relative to said film.

34. The packaging article according to claim 29, wherein said film has a heat shrinkage value less than about 25% in the machine direction at 90° C. and less than about 25% in the transverse direction at 90° C., as measured in accordance with ASTMD-2732-96 test method.

35. The packaging article according to claim 29, wherein said film includes at least one coextruded film or film laminate.

36. The packaging article according to claim 29, wherein said film includes both a coextruded film and a film laminate.

37. The packaging article according to claim 29, wherein said receptacle cavity has a draw depth of at least 0.250 in (0.635 cm).

38. The packaging article according to claim 37, wherein said receptacle cavity has a draw depth of between 0.250-10.00 in (0.635-25.4 cm).

39. The packaging article according to claim 29, wherein said article further comprises a lid which covers said mouth of said cavity to hermetically enclose a product therein.
